(19) United States
(12) Patent Application Publication
(10) Pub. No.: US 2012/0151935 A1
(43) Pub. Date: Jun. 21, 2012

(54) GAS TURBINE ENGINE AND METHOD OF OPERATING THEREOF

(75) Inventors: Ronald Scott Bunker, Waterford, NY (US); Andrei Tristan Evulet, Firenze (IT)

(73) Assignee: GENERAL ELECTRIC COMPANY, SCHENECTADY, NY (US)

(21) Appl. No.: 12/971,097

(22) Filed: Dec. 17, 2010

(51) Int. Cl. F02C 6/00; F02C 7/08

(52) U.S. Cl. 60/774; 60/39.5

(57) ABSTRACT

A method for operating a gas turbine engine includes compressing an air stream in a compressor and generating a post combustion gas by combusting a compressed air stream exiting from the compressor in a combustor. The post combustion gas is expanded in a first turbine. The expanded combustion gas exiting from the first turbine is split into a first stream and a second stream. The first stream of the expanded combustion gas is combusted in a reheat combustor. The reheat combustor is cooled using the second stream of the expanded combustion gas.

### BACKGROUND

The invention relates generally to gas turbines engines, and in particular, to cooling of a reheat combustor in a gas turbine engine.

A conventional gas turbine engine includes a compressor for compressing air (sometime referred to as an oxidant as the air has oxidizing potential due to the presence of oxygen), which is mixed with fuel in a combustor and the mixture is combusted to generate a high pressure, high temperature gas stream, referred to as a post combustion gas. The post combustion gas is expanded in a turbine (high pressure turbine), which converts thermal energy from the post combustion gas to mechanical energy that rotates a turbine shaft.

Generally, during the process of combustion in the combustor, the oxygen content in the air is not fully consumed. As a result, the hot post combustion gas, exiting from the high pressure turbine, is associated with approximately 15% to approximately 18% by mass of oxygen and therefore has the potential of oxidizing more fuel. Some gas turbine engines, therefore, deploy a reheat combustor, where the post combustion gas is re-combusted after mixing with additional fuel. The re-combusted post combustion gas is expanded in another turbine section (low pressure turbine) to generate additional power. The deployment of the reheat combustor and the low pressure turbine therefore utilizes the oxidizing potential of the post combustion gas, thereby increasing the efficiency of the engine.

The reheat combustors, however, during operation, possess a high demand for cooling air, which is generally provided by extracting a stream of air from the compressor. The extraction of air reduces the engine efficiency, as the stream of extracted air is unavailable for expansion in the high pressure turbine. The extraction of compressor air for cooling the reheat combustor therefore reduces the benefits of deploying the reheat combustor.

It is therefore desirable to have an alternate method to cool the reheat combustor without adversely affecting the engine efficiency.

### BRIEF DESCRIPTION

In accordance with an embodiment of the present invention, a method for operating a gas turbine engine is disclosed. The method includes compressing an air stream in a compressor and generating a post combustion gas by combusting a compressed air stream exiting from the compressor in a combustor. The post combustion gas is expanded in a first turbine. The expanded combustion gas exiting from the first turbine is split into a first stream and a second stream. The first stream of the expanded combustion gas is combusted in a reheat combustor. The reheat combustor is cooled using the second stream of the expanded combustion gas.

In accordance with another embodiment of the present invention, a gas turbine engine is disclosed. The gas turbine engine includes a compressor for compressing air and a combustor for generating a post combustion gas by combusting a compressed air exiting from the compressor. The gas turbine engine also includes a first turbine for expanding the post combustion gas. The gas turbine engine further includes a splitting zone for splitting an expanded combustion gas exiting from the first turbine into a first stream and a second stream. The gas turbine engine also includes a reheat combustor for combusting the first stream of the expanded combustion gas. The reheat combustor is cooled using the second stream of the expanded combustion gas.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a gas turbine engine in accordance with an embodiment of the invention.

FIG. 2 illustrates a gas turbine engine with an aerodynamic coupling between a first and second turbine in accordance with an embodiment of the present invention.

FIG. 3 illustrates a splitting zone and a reheat combustor of a gas turbine engine in accordance with an embodiment of FIGS. 1 and 2.

FIG. 4 illustrates a splitting zone having flow diverters in a fully open position in accordance with an embodiment of FIGS. 1 and 2.

FIG. 5 illustrates a splitting zone having flow diverters in a partially open position in accordance with an embodiment of FIGS. 1 and 2.

FIG. 6 illustrates a splitting zone having flow diverters in a closed position in accordance with an embodiment of FIGS. 1 and 2.

FIG. 7 illustrates a splitting zone having flow diverters coupled to a servomotor controlled by a controller.

### DETAILED DESCRIPTION

As discussed in detail below, embodiments of the present invention provide a method for cooling a reheat combustor of a gas turbine engine. This invention may, however, be embodied in many different forms and should not be construed as limited to the embodiments set forth herein; rather these embodiments are provided so that this disclosure will be thorough and complete and will fully convey the scope of the invention to those skilled in the art.

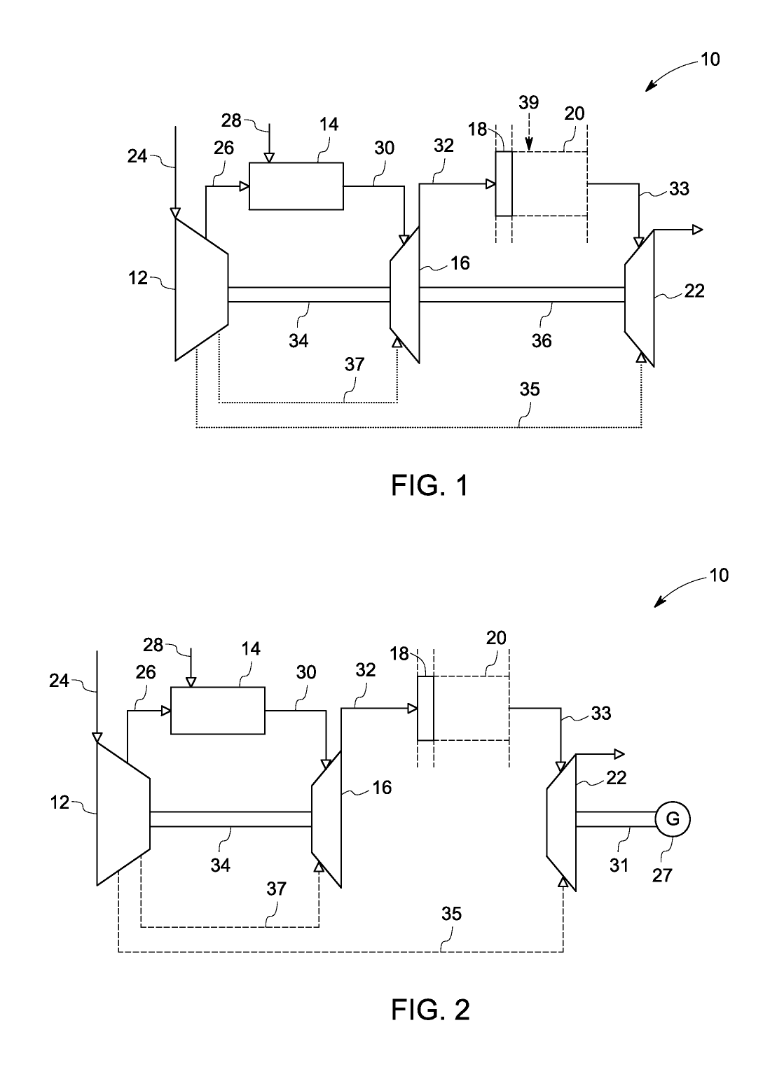

FIG. 1 illustrates a gas turbine engine 10 in accordance with an embodiment of the invention. The FIG. 1 illustrates a compressor 12, a combustor 14, a first turbine 16, a splitting zone 18, reheat combustor 20, and a second turbine 22. An air stream 24 comprising atmospheric air is fed into the compressor 12 for compression to the desired temperature and pressure. After compression, the air stream 24 exits the compressor 12 as a compressed air stream 26 and is mixed with a fuel stream 28 in the combustor 14. The mixture is ignited (combusted) in the combustor 14 resulting in a high temperature, high pressure stream of a post combustion gas 30. The post combustion gas 30 is expanded in the first turbine 16 to convert thermal energy associated with the post combustion gas 28 into mechanical energy and exits the first turbine 16 as an expanded combustion gas 32. According to an embodiment, the first turbine 16 is coupled to the compressor 12 via a shaft 34 and drives the compressor 12. In a specific embodiment, the first turbine 16 is a high pressure turbine.

The expanded combustion gas 32 is associated with certain amount of unutilized heated oxygen (about 15% to about 18% by mass). Therefore, instead of releasing the expanded combustion gas 32 in the atmosphere, the gas turbine engine 10 deploys the reheat combustor 20 and the second turbine 22 to generate additional power. According to an embodiment, prior to entering the reheat combustor 20, the expanded combustion gas 32 is routed through the splitting zone 18, where the expanded combustion gas 32 is split into two streams (illustrated in subsequent figures). A first stream of the expanded combustion gas 32 is combusted in the reheat combustor 20, whereas a second stream of the expanded combustion gas 32 is utilized for cooling the reheat combustor 20. Details of the splitting zone 18 and the splitting of the expanded combustion gas 32 are further discussed in conjunction with subsequent figures. After utilizing for cooling, the second stream of the expanded combustion gas 32 is mixed with the combusted first stream in the reheat combustor 20 and the mixture is fed into the second turbine 22 as a flow 33. It should be noted herein that the second stream of the expanded combustion gas 32, after being used for cooling of the reheat combustor 20, may partially or entirely participate in the combustion process within the reheat combustor 20. The flow 33 is expanded in the second turbine 22 to generate power. In an embodiment, the second turbine 22 is coupled to the first turbine 16 by a shaft 36.

The FIG. 1 also illustrates a stream of compressor air 35 and a stream of compressor air 37 drawn from various stages of the compressor 12 for cooling of the first turbine 16 and the second turbine 22 respectively. Conventionally, during operation of a gas turbine engine, air is drawn from various stages of the compressor for cooling the various components such as the combustor, the reheat combustor and the high pressure and low-pressure turbines. The use of compressor air for cooling the various components results in a loss of efficiency of the conventional gas turbine engine as the compressor air fraction is utilized for cooling is unavailable for complete acceleration and expansion in the high-pressure turbine. It should be noted herein that such loss of efficiency in the conventional gas turbine engine is greatest for the compressor air used to cool the reheat combustor and the low-pressure turbine. The present invention proposes use of the expanded combustion gas 32 for cooling the reheat combustor 20, thereby decreasing the quantity of compressor air extracted for cooling purposes and improving the efficiency.

In an embodiment of the invention, the second stream of the expanded combustion gas is mixed with a coolant 39 and the mixture is utilized for cooling the reheat combustor 20. Coolant 39 may be introduced into the reheat combustor 20 by any suitable means. For example, coolant 39 may be introduced through a series of circumferentially spaced inlet nozzles placed downstream of the extraction location of expanded combustion gas 32, but upstream of the reheat combustor liner coolant injection holes (not shown in FIG. 1), such that expanded combustion gas 32 and coolant 39 have sufficient volume and time to mix. In a specific embodiment, the coolant 39 comprises compressor air. It should be noted that using some compressor air as coolant 39 along with a portion of the expanded combustion gas 32 for cooling still saves considerable amount of compressor air as compared to the conventional mechanism of cooling the reheat combustor solely by compressor air. In another embodiment, the coolant comprises steam.

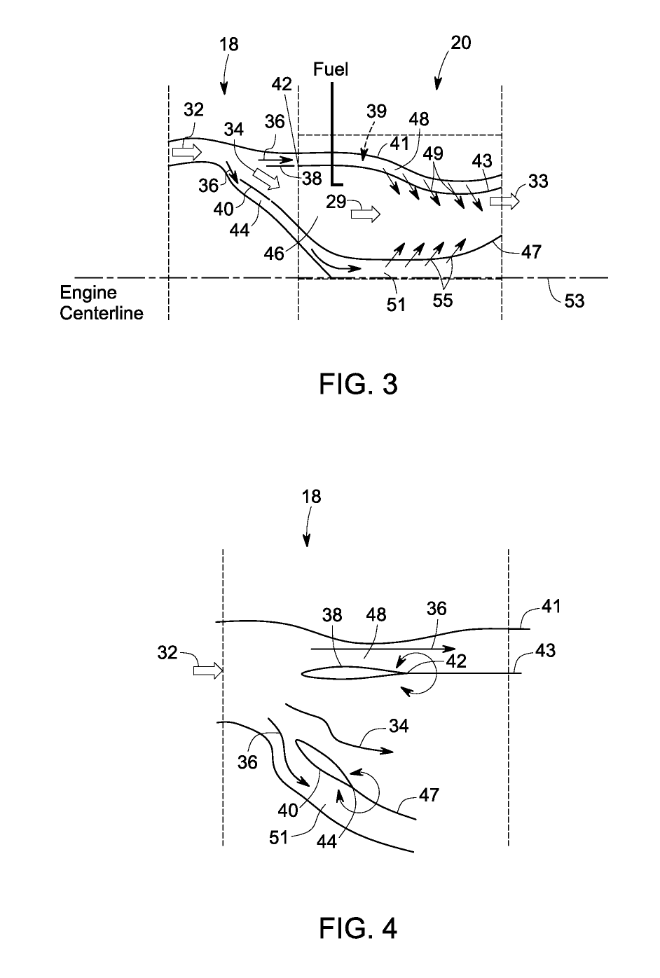

In some embodiments, the temperature of the expanded combustion gas 32 is in a range of about 1500 degrees Fahrenheit to about 1600 degrees Fahrenheit. In a specific embodiment, the expanded combustion gas 32 is utilized for cooling the reheat combustor 20 such that the temperature of any metallic material temperature of the reheat combustor 20 stays below 1700 degrees Fahrenheit or lower, for example. A reheat combustor gas 29 (shown in FIG. 3) may have temperature in the range of 2200 to 3200 degrees Fahrenheit depending on the engine design and operating point. The amount and effectiveness of the cooling mechanisms will dictate the resulting material temperatures.

FIG. 2 shows an alternate embodiment wherein the second turbine 22 is aerodynamically coupled to the first turbine 16 but on an independent shaft 31. In this embodiment, the first turbine 16 drives the compressor 12 and the second turbine 22 provides shaft power, for example to drive an electric power generator 27.

FIG. 3 illustrates a blown up view of the splitting zone 18 and the reheat combustor 20. In the splitting zone 18, the expanded combustion gas 32 is split into a first stream 34 and a second stream 36 using a diverter 38 and a diverter 40. It should be noted the diverters 38, 40 are exemplary embodiments for splitting the expanded combustion gas 32. Various other means can be deployed for splitting the expanded combustion gas 32. Also, in other exemplary embodiments, the diverter system may not be limited to two diverters. In other words, there may be one or more such diverters, or a diverter system, deployed about a periphery of the reheat combustor 20. According to an embodiment, the diverter 38 and the diverter 40 are positioned upstream of the reheat combustor 20. In a specific embodiment, the diverter 38 and the diverter 40 are coupled to the body of the reheat combustor 20 at a location 42 and a location 44 respectively through hinge joints. The diverter 38 and the diverter 40 can rotate about the hinge joints at the location 42 and the location 44 and control the splitting of the flow of the expanded combustion gas 32 into the first stream 34 and the second stream 36 as will be discussed in subsequent figures. The first stream 34 constitutes the main flow to the reheat combustor 20 and undergoes combustion in a main chamber 46 of the reheat combustor 20.

In an embodiment, the reheat combustor 20 comprises a casing 41 and an outer liner 43. The diverter 38 and the diverter 40 are configured to split the expanded combustion gas 32 in such a way that the second stream 36 of the expanded combustion gas 32 flows through passage 48 between the casing 41 and the outer liner 43 of the reheat combustor 20, and passage 51 between an inner liner 47 and an engine center line 53. The second stream 36 is used to cool the inner and outer liners 43, 47 of the reheat combustor 20. The second stream 36 is used to cool the reheat combustor 20 through various mechanisms. In an embodiment, impingement cooling is employed, wherein the second stream 36 is impinged on the cold surface of the reheat combustor 20, that is the surface in contact with the second stream 36. In another embodiment, effusion cooling or film cooling is employed, wherein the second stream 36 is injected through injection holes 49 of the liners 43, 47 to form a thin film cooling layer over the surface of the reheat combustor 20 that is bounded by the reheat combustion gases. It is to be noted that a combination of two or more mechanisms can also be employed to cool the reheat combustor 20 using the second stream 36.

After being utilized for cooling, the second stream 36 enters the main chamber 46 of the reheat combustor 20 as illustrated in the figure. The outer liner 43 of the reheat combustor 20 may include the injection holes 49, which facilitate the entry of the second stream 36 in the main chamber 46. The injection holes 49 may be used for dilution or film cooling purposes. In some embodiments, the inner liner 47 may include the injection holes 55. After entering the main chamber 46, the second stream 36 gets mixed with the first stream 34 (undergoing combustion) and in the process a fraction of the second stream 36 may also undergo combustion in the main chamber 46. The mixture of the combusted first stream 34 and the second stream 36 (a part of which may have undergone combustion) leaves the reheat combustor 20 as the flow 33. The flow 33 is expanded in the second turbine 22 (illustrated in FIG. 1).

In some embodiments, the second stream 36 is mixed with the coolant 39 in the passage 48 and the mixture is used to cool the reheat combustor 20. In a specific embodiment, the coolant 39 is air drawn from a stage of the compressor 12 (FIG. 1). In another embodiment, the coolant 39 is steam.

FIG. 4 illustrates a further blown up view of the splitting zone 18. The splitting zone 18 comprises the diverter 38 and the diverter 40 positioned upstream of the reheat combustor 20 (FIG. 1). In the illustrated embodiment, the diverter 38 and the diverter 40 are coupled to the body of the reheat combustor 20 (illustrated in FIGS. 1 and 2) via hinge joints at the location 42 and the location 44 respectively. According to an embodiment, each of the diverters 38, 40 have an aerodynamic shape to minimize flow separations and associated pressure losses. The diverters 38, 40 split the flow of the expanded combustion gas 32 into the first stream 34 and the second stream 36. The rotations of the diverters 38, 40 about respective hinge joints regulate the amount of second stream 36 to be split from the post combustion gas 32 for cooling the reheat combustor 20 (illustrated in FIG. 1,2). The FIG. 4 illustrates the diverters 38, 40 in a fully open position, which enables drawing of maximum mass of second stream 36 via the passages 48, 51 from the expanded combustion gas 32. The greater the firing temperature of the reheat combustor 20, the greater is the cooling requirement for the reheat combustor 20. Therefore with increasing firing temperature of the reheat combustor 20, the opening of the passages 48, 51 is increased through rotation of the diverters 38, 40 so that an increasing amount of the second stream 36 can be drawn from the post combustion gas 32 for the cooling of the reheat combustor 20.

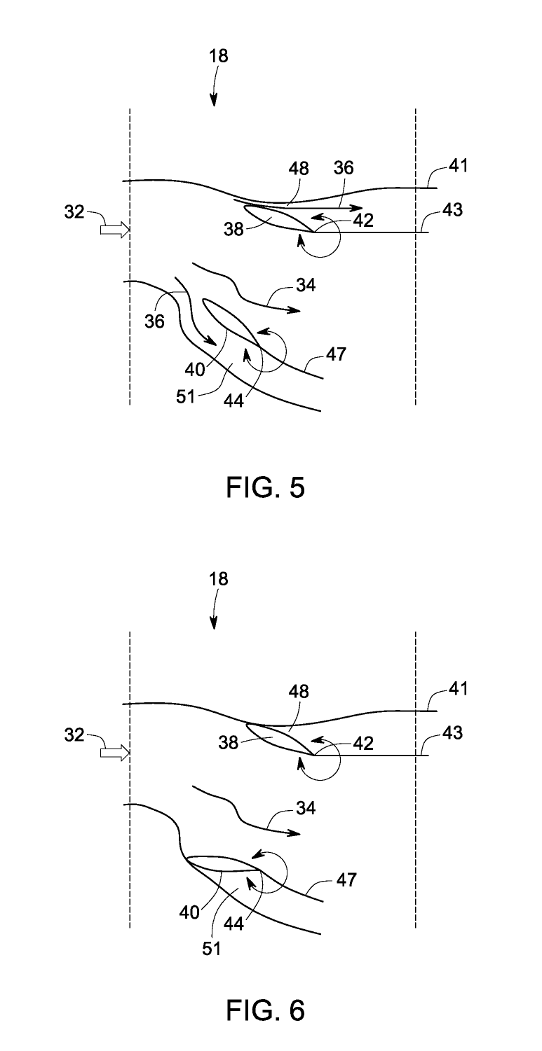

FIG. 5 illustrates the splitting zone 18 with the diverters 38, 40 in a partially open position. As compared with the fully open position of the diverters 38, 40 in FIG. 4, the partially opened position reduces the opening of the passages 48, 51 for the flow of the second stream 36, thereby reducing the mass of second stream 36 extracted from the expanded combustion gas 32. As the load on the turbine reduces, the cooling demand for the reheat combustor (FIG. 1) reduces and the diverters are rotated from a fully open position to the partially open position.

FIG. 6 illustrates the splitting zone 18 with the diverters 38, 40 in a closed position. As compared with the fully open position of the diverters 38, 40 illustrated in FIG. 4 and the partially open position illustrated in FIG. 5, the closed position allows only a small leakage flow of the second stream 36 and almost all of the post combustion gas 32 enters the reheat combustor 20 (FIG. 1) as the first stream 34. The diverters 38, 40 are usually kept in a closed position when there is no requirement for the reheat combustor 20 (FIG. 1) to combust the expanded combustion gas 32. In such a scenario there is no requirement for cooling of the reheat combustor 20 (FIG. 1) and hence no expanded combustion gas 32 is diverted as second stream 36 (FIG. 4,5) for cooling of the reheat combustor 20 (FIG. 1).

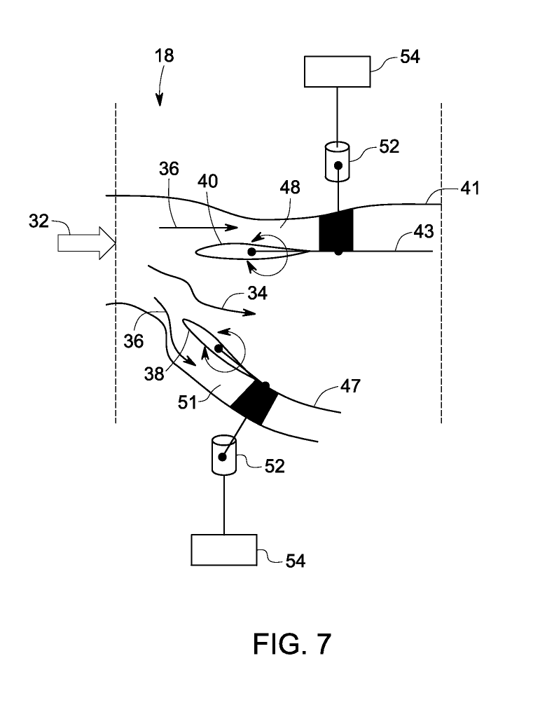

FIG. 7 illustrates the splitting zone 18 with the diverter 38 and the diverter 40 coupled to a servomotor 52, which is controlled by a controller 54. The controller 54 controls the rotation of the diverter 38 and the diverter 40 via the servomotor 52, thereby regulating the opening of the passages 48, 51. The aerodynamically shaped flow diverters 38, 40 are configured to split the expanded combustion gas based on an operating point of the gas turbine engine. The operating point can be a function of load demand, inlet air temperature, fuel type, or the like. In an embodiment, the controller 54 controls splitting of the expanded combustion gas 32 based on the load on the gas turbine engine 10 (FIG. 1), or the firing temperature of the reheat combustor 20, causing the diverter 38 and the diverter 40 to be in a fully open, partially open, or closed positions as discussed in conjunction with FIGS. 4, 5 and 6. In a specific embodiment, the opening of the passages 48, 51 is adjusted by rotation of the diverters 38, 40 such that the second stream 36 is about 20% to about 45% by mass of the flow of the post combustion gas 32.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of operating a gas turbine engine, the method comprising:
compressing an air stream in a compressor;
generating a post combustion gas by combusting a compressed air stream exiting from the compressor in a combustor;
expanding the post combustion gas in a first turbine;
splitting an expanded combustion gas exiting from the first turbine into a first stream and a second stream;
combusting the first stream of the expanded combustion gas in a reheat combustor; and
cooling the reheat combustor using the second stream of the expanded combustion gas.

2. The method of claim 1 further comprising mixing the second stream of the expanded combustion gas after cooling the reheat combustor with a combusted first stream of the expanded combustion gas of the reheat combustor.

3. The method of claim 2 further comprising expanding a mixture comprising the second stream of the expanded combustion gas and the combusted first stream of the reheat combustor, in a second turbine.

4. The method of claim 1, wherein the second stream of the expanded combustion gas is about 20% to about 45% by mass of the expanded combustion gas exiting from the first turbine.

5. The method of claim 1, wherein cooling comprises cooling the reheat combustor using the second stream of the expanded combustion gas through at least one of impingement cooling, effusion cooling, and film cooling.

6. The method of claim 1 further comprising mixing the second stream of the expanded combustion gas with a coolant before cooling the reheat combustor.

7. The method of claim 6, wherein cooling comprises cooling the reheat combustor using a mixture comprising the second stream of the expanded combustion gas and the coolant through at least one of impingement cooling, effusion cooling, and film cooling.

8. The method of claim 6, wherein the coolant comprises air extracted from the compressor.

9. The method of claim 6, wherein the coolant comprises steam.

10. A gas turbine engine, comprising:
a compressor for compressing air;
a combustor for generating a post combustion gas by combusting a compressed air exiting from the compressor;
a first turbine for expanding the post combustion gas;
a splitting zone for splitting an expanded combustion gas exiting from the first turbine into a first stream and a second stream; and
a reheat combustor for combusting the first stream of the expanded combustion gas, wherein the reheat combustor is cooled using the second stream of the expanded combustion gas.

11. The gas turbine engine of claim 10, wherein the splitting zone comprises one or more aerodynamically shaped flow diverters configured to split the expanded combustion gas in such a way that the second stream of the expanded combustion gas flows through at least one of an inner liner and an outer liner of the reheat combustor.

12. The gas turbine engine of claim 11, wherein the at least one of the inner liner, and the outer liner of the reheat combustor comprises injection holes for the second stream of the expanded combustion gas to enter the reheat combustor after cooling the reheat combustor and mix with a combusted first stream.

13. The gas turbine engine of claim 12, further comprising a second turbine for expanding a mixture of a combusted first stream from the reheat combustor and the second stream of expanded combustion gas.

14. The gas turbine engine of claim 13 further comprising a shaft coupling the first turbine and the second turbine.

15. The gas turbine engine of claim 11, wherein the one or more aerodynamically shaped flow diverters are positioned upstream of the reheat combustor.

16. The gas turbine engine of claim 11, wherein the one or more aerodynamically shaped flow diverters are mechanically coupled to the reheat combustor.

17. The gas turbine engine of claim 11, wherein the one or more aerodynamically shaped flow diverters are configured to split the expanded combustion gas based on an operating point of the gas turbine engine.

18. The gas turbine engine of claim 11, further comprising at least one servomotor for actuating the one or more aerodynamically shaped flow diverters to split the expanded combustion gas.

19. The gas turbine engine of claim 18, further comprising at least one servomotor for controlling the actuation of the one or more aerodynamically shaped flow diverters.

20. The gas turbine engine of claim 18, wherein actuating the one or more aerodynamically shaped flow diverters comprises positioning the one or more aerodynamically shaped flow diverters in a fully open, partially open, or a closed position.

21. The gas turbine engine of claim 10, wherein the reheat combustor further comprises an inner liner and an outer liner, wherein the inner liner and the outer liner are cooled using the second stream of the expanded combustion gas.

22. A method comprising:
splitting a flow of an expanded combustion gas from a first turbine into a first stream and a second stream;
combusting the first stream of the expanded combustion gas in a reheat combustor; and
cooling the reheat combustor using the second stream of the post combustion gas.
